(19) United States
(12) Patent Application Publication
(10) Pub. No.: US 2013/0284588 A1
(43) Pub. Date: Oct. 31, 2013

(54) METHOD FOR SCALING PLASMA REACTORS FOR GAS TREATMENT AND DEVICES THEREFROM

(71) Applicant: Old Dominion University Research Foundation, (US)

(72) Inventors: Muhammad Arif Malik, Norfolk, VA (US); Karl H. Schoenbach, Norfolk, VA (US); Richard Heller, Norfolk, VA (US)

(73) Assignee: OLD DOMINION UNIVERSITY RESEARCH FOUNDATION, Norfolk, VA (US)

(21) Appl. No.: 13/836,440

(22) Filed: Mar. 15, 2013

Related U.S. Application Data
(63) Continuation-in-part of application No. PCT/US11/54111, filed on Sep. 30, 2011.
(60) Provisional application No. 61/388,743, filed on Oct. 1, 2010.

(51) Int. Cl. B03C 9/00

(52) U.S. Cl. CPC B03C 9/00
USPC 204/164; 422/168

(57) ABSTRACT

Systems and methods for the treatment of a gas are provided. A method includes providing multiple discharge chambers defined by dielectric sections, where each of the discharge chambers comprises sets of electrodes for producing electric fields in the discharge chambers, where the dielectric sections and the sets of electrodes are arranged to define a volume that inhibits the formation of volume-streamers and the discharge chambers are configured to either prevent pulsed electric fields generated in adjacent discharge chambers from substantially interacting or to allow interaction in constructive way. The method also includes directing the gas into the discharge chambers and treating the gas using a corona discharge in the discharge chambers produced by a pulsed electric field generated by each of the sets of the first and second electrodes in the discharge chambers, where the pulsed electric field is configured to produce the corona discharge to have surface-streamers and volume-streamers.

### CROSS-REFERENCE TO RELATED APPLICATIONS

This application is a continuation in part of, under 35 U.S.C. 111, and claims priority to International Patent Application No. PCT/US2011/054111, filed Sep. 30, 2011 and entitled METHOD FOR SCALING PLASMA REACTORS FOR GAS TREATMENT AND DEVICES THEREFROM, which claims priority to U.S. Provisional Patent Application No. 61/388,743, filed Oct. 1, 2010 and METHOD FOR SCALING PLASMA REACTORS FOR GAS TREATMENT AND DEVICES THEREFROM, both of which are herein incorporated by reference in their entirety.

### FIELD OF THE INVENTION

The invention relates to devices and methods for chemical processing. More specifically, the invention relates to an energy efficient device for the treatment of a gas including the decomposition of chemical compounds within a gas, such as the abatement of pollution within an exhaust gas by the use of an efficient corona discharge plasma reactor.

### BACKGROUND

The plasma that is typically employed for destroying pollutants in gaseous emissions is typically generated by a high voltage electrical discharge. Such a plasma usually comprises thin plasma channels (streamers) propagating in a gas phase between two electrodes. These streamers or plasma channels are generally referred to as “volume-streamers” or “volume-plasmas”. However, the streamers can also propagate at solid-gas interfaces. Such streamers generally occur as a surface-flashover, typically observed during partial breakdown of insulators in high voltage equipment and transmission lines. These types of plasma streamers are generally referred to as surface-streamers or surface-plasmas. In general, surface-streamers differ from volume-streamers in many respects due to the stronger interaction in surface-streamers between the plasma and the solid surface. For example, the surface-streamers propagate faster than volume-streamers, which is believed to be due to photo-electron extraction from the surface contributing to collision ionization in front of the streamer head.

In general, one can expect more enhanced absorption and stabilization of chemically active species on a solid surface in contact with a plasma, as in the case of surface-plasma, as compared to volume-plasma. This can be shown by the typically observed retention of positive charges and free radicals. In surface-plasma, the adsorbed active species can be utilized in surface mediated reactions with the pollutants adsorbed from the gas phase. The products can then be released into the gas phase. This cycle of adsorption and regeneration can then be repeated. In general, the yield of the surface mediated reactions can be higher than the gas phase reactions because the backward reactions and conversions into undesired by-products can be minimized in the case of surface mediated reactions.

The potential advantage of surface-streamer discharges, as compared to volume-streamer discharges, has been shown in studies regarding the destruction of toxic volatile organic compounds (VOCs). In general, the energy cost for destruction of the VOCs was found to be five to seven times lower in surface-streamer discharges as compared with volume-streamer discharges. The destruction of VOCs in plasma starts with partial oxidation of the organic molecules. If the plasma reactor is fed with diesel fuel diluted in air, the hydrocarbons comprising the fuel can be partially oxidized in the plasma. The partially oxygenated hydrocarbons can then be employed as an onboard source of efficient reducing agents in the process of hydrocarbon assisted selective catalytic reduction of NOₓ (H—SCR) from diesel engine exhaust. The partial oxidation of hydrocarbons then becomes coupled with conversion of NO into NO₂ in the plasma reactor, which is also desirable for more efficient destruction of NOₓ in H—SCR processes. Previous studies have proven that surface-streamer plasma reactor is significantly more energy efficient for conversion of NO into NO₂ as compared with volume-streamer plasma reactor.

### SUMMARY

Embodiments of the invention concern systems and methods for chemical processing. In a first embodiment, a system for the treatment of a gas is provided. The system includes a gas inlet for receiving the gas prior to treatment and a plurality of dielectric sections defining two or more discharge chambers coupled to the gas inlet. The system further includes first and second electrodes disposed in each of the discharge chambers and electrically conductive shield portions positioned between adjacent ones of the discharge chambers. The system also includes a gas outlet coupled to the discharge chambers and a circuit in communication with the shield portions and the first and the second electrodes in the discharge chambers. In the system, the circuit is configured for creating a pulsed electric field between the first and second electrodes in each of the discharge chambers capable of producing a corona discharge in the discharge chambers having surface-streamers and volume-streamers and for applying a reference voltage to the shield portions. Further, the plurality of dielectric sections and the first and second electrodes are arranged so that a greater portion of overall energy density within the discharge chambers is due to the surface-streamers.

In a second embodiment of the invention, a system for the treatment of a gas is provided. The system includes a gas inlet for receiving the gas prior to treatment and a plurality of dielectric sections defining two or more discharge chambers coupled to the gas inlet. The system also includes one or more sets of first and second electrodes disposed in each of the discharge chambers and a gas outlet coupled to the discharge chambers. The system further includes a circuit in communication with the sets of first and second electrodes in the discharge chambers. In the system, the circuit is configured for creating a pulsed electric field for each of the sets of the first and second electrodes capable of producing a corona discharge in a corresponding one of the discharge chambers having surface-streamers and volume-streamers. Additionally, the plurality of dielectric sections and the sets of first and second electrodes are arranged so that a greater portion of overall energy density within the discharge chambers is due to the surface-streamers. Further, the sets of first and second electrodes associated with adjacent ones of the discharge chambers are positioned in a staggered arrangement such that the pulsed electric field in a first of the adjacent ones of the discharge chambers does not substantially interacting with the pulsed electric field in a second of the adjacent ones of discharge chambers.

In a third embodiment of the invention, a method for the treatment of a gas is provided. The method includes providing two or more discharge chambers defined by a plurality of dielectric sections, where each of the discharge chambers comprises one or more sets of first and second electrodes for producing electric fields in the discharge chambers, where the plurality of dielectric sections and the sets of first and second electrodes are arranged to define a volume in each of the discharge chambers that inhibits the formation of volume-streamers, and where the discharge chambers are configured to prevent pulsed electric fields generated in adjacent ones of the discharge chambers from substantially interacting. The method also includes directing the gas into the discharge chambers. The method further includes treating the gas using a corona discharge in the discharge chambers produced by a pulsed electric field generated by each of the sets of the first and second electrodes in the discharge chambers, where the pulsed electric field are configured to produce the corona discharge to have surface-streamers and volume-streamers.

In a fourth embodiment of the invention, a system for the treatment of a gas is provided. The system includes a gas inlet for receiving the gas prior to treatment and a plurality of dielectric sections defining two or more adjacent discharge chambers coupled to the gas inlet. The system also includes first and second electrodes disposed in each of the discharge chamber and a gas outlet coupled to the discharge chambers. The system further includes a circuit in communication with the shield portions and the first and the second electrodes in the discharge chambers. In the system, the circuit is configured for creating a pulsed electric field between the first and second electrodes in each of the discharge chambers capable of producing a corona discharge in the discharge chambers having surface-streamers and volume-streamers. Further, the plurality of dielectric sections and the first and second electrodes are arranged so that a greater portion of overall energy density within the discharge chambers is due to the surface-streamers. Finally, the first and second electrodes in a first of the discharge chambers and the first and second electrodes in a second of the discharge chambers adjacent to the first of the discharge chambers are positioned in a staggered arrangement.

In a fifth embodiment of the invention, a system for the treatment of a gas is provided. The system includes a gas inlet for receiving the gas prior to treatment and a plurality of dielectric sections defining two or more adjacent discharge chambers coupled to the gas inlet. In the system, first and second electrodes are disposed in each of the discharge chambers. The system also includes a gas outlet coupled to the discharge chambers and a circuit in communication with the first and the second electrodes in the discharge chambers. In the system, the circuit is configured for creating a pulsed electric field between the first and second electrodes. Further, the plurality of dielectric sections and the first and second electrodes are arranged so that a greater portion of overall energy density from a corona discharge within the discharge chambers is due to the surface-streamers. Also, the first electrode in a first of the discharge chambers and the second electrode in a second of the discharge chambers adjacent to the first of the discharge chambers are co-located. Additionally, the second electrode in the first of the discharge chambers and the first electrode in the second of the discharge chambers adjacent to the first of the discharge chambers are also co-located.

### DESCRIPTION OF THE DRAWINGS

FIGS. 1A and 1B show top and side views, respectively, and FIG. 1C is a cross-section view (through cutline C-C) of a plasma reactor or system, configured for encouraging primarily surface-streamers;

FIG. 2 is a partial cross-section diagram of a first exemplary configuration for a gas treatment device in accordance with an embodiment of the invention;

FIG. 3A shows top-down and cross section views (through cutline A-A) of a discharge chamber substantially similar to that illustrated in FIGS. 1A-1C;

FIG. 3B also shows top-down and cross section views (through cutline A-A) of a discharge chamber substantially similar to that illustrated in FIGS. 1A-1C, but including a conductive extending along an outer surface of the dielectric layer associated with the anode electrode and coupled to the cathode electrodes;

FIG. 3C shows top-down and cross section views (through cutline A-A) of two, stacked discharge chambers substantially similar to that illustrated in FIG. 3B;

FIGS. 4A and 4B show plots of electric potential distribution for the configurations of FIGS. 3A and 3B, respectively;

FIG. 5A shows a photograph of the discharges in a discharge chamber similar to that in FIG. 3A;

FIG. 5B shows a photograph of the discharge in a discharge chamber similar to that in FIG. 3B;

FIGS. 6A and 6B show one exemplary configuration of a gas treatment device arranged in accordance with an embodiment of the invention;

FIG. 7A shows an exploded view of a single chamber treatment device in accordance with an embodiment of the invention;

FIG. 7B shows an assembled view of the device in FIG. 7A;

FIG. 7C shows an assembled view of another single chamber treatment device in accordance with another embodiment of the invention;

FIG. 7D shows an assembled view of a multi-chamber treatment device in accordance with an embodiment of the invention;

FIG. 8 shows a partial cross-section diagram of another exemplary configuration for a gas treatment device in accordance with an embodiment of the invention;

FIG. 9, shows an x-y plot of energy cost (eV/molecule) as a function of NO conversion %, for a gas treatment device configured in accordance with FIGS. 6A and 6B;

FIG. 10 shows a plot of NO to NO₂ conversion when one or two reactors was operated;

FIG. 11 shows an x-y plot of energy cost (eV/molecule) as a function of NO conversion %, for a gas treatment device configured to operate in surface-streamer mode and compared with a device configured to operate in volume-streamer mode;

FIGS. 12A, 12B, and 12C show views of a non-thermal plasma treatment system in which the plasma discharges consist of pulsed corona discharges in air;

FIGS. 13A, 13B, and 13C show views of a non-thermal plasma treatment system in which the plasma discharges consist of sliding discharges (with no shields);

FIGS. 14A, 14B, and 14C show views of a non-thermal plasma treatment system in which the plasma discharges consist of shielded sliding discharges in accordance with the various embodiments of the invention

FIGS. 15A, 15B, and 15C show views of a non-thermal plasma treatment system in which the plasma discharges consist of plasma enhanced sliding discharges in accordance with the various embodiments of the invention;

FIG. 16 shows a plot of energy per pulse versus peak voltage curves for different type of plasmas formed in the reactors shown in FIGS. 12A-15C;

FIG. 17 shows a plot of NO conversion versus specific input energy curves in the different treatment systems of FIGS. 12A-15C;

FIG. 18 shows a system including a gas treatment device configured in accordance with an embodiment of the invention, and supporting electrical circuitry; and

FIG. 19 shows a detailed block diagram of a computing device which can be implemented as control system.

### DETAILED DESCRIPTION

The invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

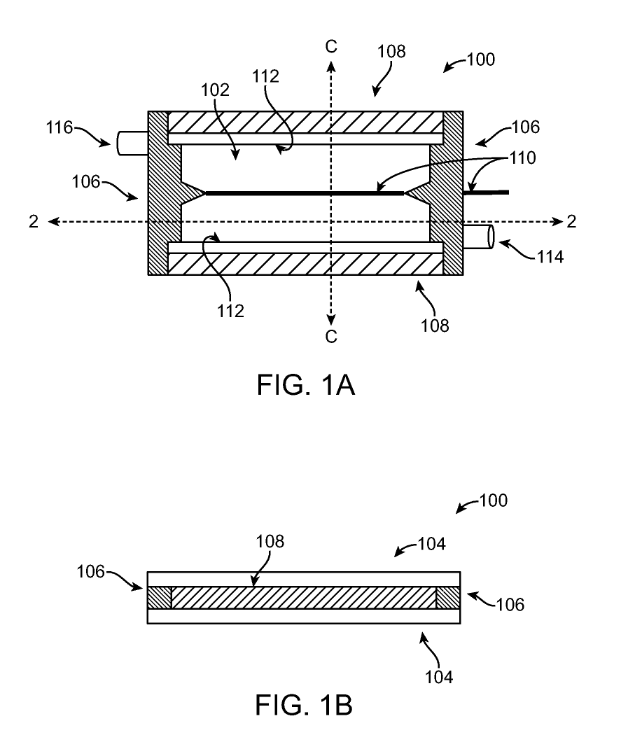

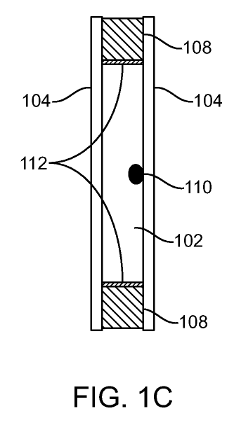

FIGS. 1A and 1B show top and side views, respectively, of a plasma reactor or system 100, configured for encouraging primarily surface-streamers, which is useful for describing the invention. FIG. 1C shows a cross-section view of system 100 through cutline C-C in FIG. 1A. As shown in FIGS. 1A-1C, the system 100 is an enclosure defining a discharge volume or chamber 102. The discharge chamber 102 is defined by a collection of surfaces. For example, as shown in FIGS. 1A-1C, the discharge chamber 102 is defined by opposing upper and lower dielectric portions or surfaces 104, opposing dielectric end portions 106, and lateral or side portions 108.

The system 100 can also include an inlet a 114 and an outlet 116 for directing gas in and out, respectively, of the discharge chamber 102. In the configuration illustrated in FIGS. 1A-1C, the system 100 is shown as including a single inlet 114 and a single outlet 116 positioned at opposing end portions 106. However, the number and placement of inlets and outlets can vary in the various embodiments.

The discharge chamber 102 further includes electrodes 110 and 112 for producing plasma in the discharge chamber 102 using a high voltage pulse. Use of a pulse prevents arcing. As shown in FIG. 1A, the system 100 includes an anode electrode 110. In FIG. 1, an anode electrode 110 is shown as a wire inserted into and extending across the length of discharge chamber 102. However, the various embodiments are not limited in this regard. For example, electrode 110 may also be a threaded rod, sharp edge, or any other localizing configuration of electrode capable of producing streamers, without limitation.

System 100 also includes one or more cathode electrodes 112. In the configuration illustrated in FIGS. 1A-1C, the second electrode is shown as a solid electrical conductor disposed on an inner surface of lateral side portions 108. However, lateral side portions 108 and electrodes 112 can be integrally formed. Further, the cathode electrodes 112 can also be in the form of a wire mesh, a plate, a wire, or other conductive electrode configuration known in the art. Additionally, the lateral side portions 108 and the electrodes 112 can be configured to permit the flow of gas into and out of gas discharge chamber 102 through cathode electrodes 112. For example, by positioning from gas inlet 114 into system 100 along lateral side portions 108 and sizing or configuring cathode electrodes 112 to allow gases to flow through cathode electrodes 112 and into discharge chamber 102. After treatment, the gas exits through another of cathode electrodes 112 and side portion 108 by gas outlet 116.

As shown in FIGS. 1A-1C, system 100 shows a substantially wire-to-plate arrangement of electrodes 110 and 112. As shown in FIG. 1C, the anode electrode 110, in this case a wire, is located at equal distance to the two cathode electrodes 112. However, the various embodiments of the invention are not limited to this exemplary configuration for a reactor. For example, a position of anode electrode 110 can vary and need not be exactly equidistant between electrode 112. Further, electrode 110 is shown in FIG. 1C as being disposed on or near a first of dielectric portions 104. However, the various embodiments are not limited in this regard and the position of electrode 110 with respect to dielectric portions 104 can vary. That, is the electrode 110 can be either placed on or near either of dielectric portions 104, equidistant between the two surface 104, or any position in between, as long as the distance of the wire to the sheets is small enough such that surface streamers are primarily generated in the system 100.

Further, the various embodiments are not limited to wire-to-plate configurations. Thus, the anode and cathode electrodes can be arranged in a wire-to-wire configuration, a point-to-wire configuration, or a point-to-plate configuration, to name a few. Further, the roles of the electrodes in the various embodiments can be reversed. That is, electrode 110 and electrode 112 can be switched to provide a cathode and an anode, respectively.

In one exemplary configuration of system 100, it can be constructed using sheets or films consisting of glass, acrylic, or other dielectric materials, as dielectric surfaces 104, a stainless steel wire of 150 micro-meter diameter as anode electrode 110, aluminum strips of 6 mm thickness as cathode electrodes 112, and Teflon or Plexiglas or silicone as end portions 106. However, the various embodiments are not limited to the exemplary materials described above. For example, dielectric surface 104 can be fabricated from ceramic sheets, such as cordierite, silicon carbide, or alumina, to name a few. Further, the electrodes 110 and 112 can be fabricated from any electrically conducting or semi-conducting materials. However, metals, such as stainless steel, copper, silver, tungsten, or alloys thereof would provide superior performance.

Exemplary dimensions for reactors using such materials and the typically achievable energy per pulse are listed in Table 1.

TABLE 1
Dimensions of discharge spaces of three reactors employed.

| | | | | Energy per pulse |
|---|---|---|---|---|
| Reactor | Length (cm) | Width (cm) | Height (cm) | J ± 1σ |
| 1 | 8 | 10 | 0.2 | 0.0085 ± 0.002 |
| 2 | 30 | 9 | 0.2 | 0.035 ± 0.008 |
| 3 | 30 | 9 | 1.4 | 0.034 ± 0.007 |
| 4 | 15 | ID**: 4.5 | — | 0.10 ± 0.01 |

In Table 1, Reactor 4 is a conventional coaxial reactor (not shown) with the discharge gap defined by the diameter of the cylinder and operating in a volume-streamer mode. Reactors 1, 2, and 3 are reactors configured in accordance with FIGS. 1A and 1B and operating in surface-streamer mode. The dimensions and achievable energy per pulse for Reactor 4 is shown for purposes of comparison.

In addition to the configuration described above, the ends of the first electrodes 110 within the discharge chamber 102 can be insulated to eliminate surface-streamer at the end portions 106. For example, a 2.5 cm part each end of the electrodes can be used to insulate electrodes 110 and 112 to eliminate surface-streamers at the end fittings. Accordingly, the effective length of the electrodes would be 5 cm less than that listed above.

Those skilled in the art will recognize that the configuration of the discharge chamber, the gas, and the electrodes will vary the effective length at which the formation of streamers is effectively constrained so that surface-streamers play a primary role in energy density. For example, spacing between the dielectric surfaces 104 may be used to reduce the dimensions of discharge chamber 102 so as to constrain the formation of volume-streamers, given the electrode configuration described above. In the embodiment of FIG. 1, a distance of 10 mm between dielectric surfaces 104 was shown to be effective to significantly reduce or eliminate the formation of volume-streamers. Smaller distances are preferable in that they increase the role of surface-streamers with a corresponding increase in energy density. The design of a plasma reactor with a discharge chamber, in which surface-streamers are predominant, is described in U.S. Pat. No. 7,298,092 to Malik et al., issued Nov. 20, 2007, the contents of which are hereby incorporated in their entirety.

Although the plasma reactors described above can generate a sufficient volume of surface-streamers to provide effective treatment, combining several of these reactors into a small space can be difficult. For example, if two of the reactors shown in FIGS. 1A and 1B are placed directly on top of each other or constructed using a common one of dielectric portions 104 and operated in parallel using a common power supply, plasma will typically be observed in one chamber only. This is believed to be due to positive surface charge that the surface plasma leaves on the dielectric surface in contact with the plasma. This charge on one side of the dielectric induces an opposite charge on the other side, which appears to change or interact with the electric field distribution in the adjacent discharge chamber. As a result, this interaction results in an electric field distribution which is not favorable to plasma formation. Further, the energy efficiency for NO to NO₂ conversion will decrease significantly for such a configuration. In other words, when two surface-plasma reactors are operated adjacent to each other, they can become electrically coupled with each other. Normally, this can occur is the electrical field of one of the reactors is sufficiently strong causing accumulation of charges on an opposing dielectric surface. As a result, plasma formation will occur in one reactor only, decreasing treatment efficiency. As a result, combining a number of such reactors in a small space, such as for an automotive exhaust treatment system, will not result in improved treatment of gases.

In view of the limitations of such combinations of reactors, the various embodiments of the invention provide systems and methods for gas treatment using multiple adjacent plasma reactors. In particular, the various embodiments of the invention provide methods and configurations for decoupling adjacent surface-plasma reactors being operated in parallel or in series. In particular, the various embodiments of the invention provide for configuring adjacent surface-plasma reactors with shield portions to prevent the inducement of opposite charges in one reactor due to surface plasma discharge in an adjacent chamber. Thus, a gas treatment device can be formed by scaling up a surface-plasma reactor by operating multiple reactors in parallel or series and positioned adjacent to each other, by separating them with a shield portion held at a reference voltage. Thus, a gas treatment device can be formed using relatively small volume discharge chambers without affecting energy efficiency, flow rate or conversion of the pollutant.

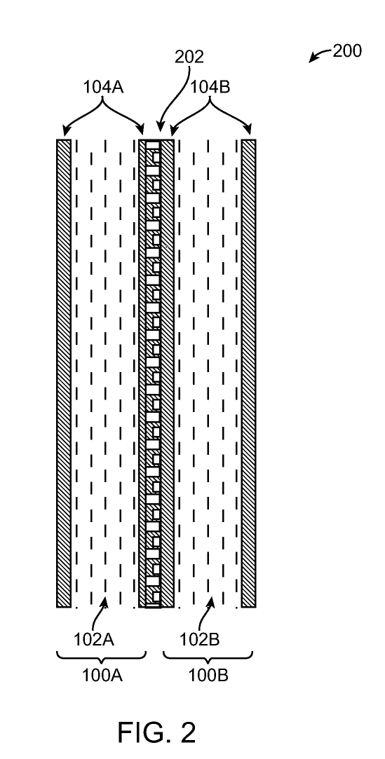

FIG. 2 is a partial cross-section diagram of a first exemplary configuration for a gas treatment device 200 in accordance with an embodiment of the invention. In particular, FIG. 2 is a stacked arrangement of two of system 100 (reactors 100A and 100B), where the cross section shown in FIG. 2 is a portion of the cross-section along cutline 2-2 in FIG. 1A for each of reactors 100A and 100B. That is, each of reactors 100A and 100B is configured substantially similar to system 100 in FIGS. 1A-1C.

The partial cross-section of device 200 shows the top and bottom dielectric portions 104A and 104B for each of system 100A and 100B, respectively. In device 200, the decoupling between reactors 100A and 100B is provided by introducing an electrically conductive shield portion 202 between the reactors 100A and 100B. Particularly, the shield portion 202 is disposed between the contacting ones of dielectric portions 104A and 104B. Thus, this shield portion 202 can decouple the two reactors 100A and 100B by providing a conducting medium which prevents the induction of charges on the dielectric which is part of the neighboring reactor.

In operation, the shield portion 202 can be connected to a reference voltage that is the same or lower than that of the electrodes in each of system 100A and 100B. For example, the shield portion 202 can be coupled to ground. As a result, the electric field generated in first of discharge chambers 102A is effectively blocked from entering a second of discharge chambers 102B. The electric charge induced on the dielectric surface is transported by the conductive shield. Accordingly, the lack of induced charges results in the ability to generate plasma in both adjoining discharge chambers 102A and 102B.

In some embodiments of the invention, the shield portion 202 and the electrodes in reactors 100A and 100B can be separately biased, as described above. However, in some configurations, the shield portion 202 and the cathode electrodes in reactors 100A and 100B can be biased and/or electrically connected. Such a configuration simplifies the circuitry required for operating device 200. That is, separate circuits are not required for biasing shield portion 202 and the cathode electrodes in reactors 100A and 100B. Further, since these portions are substantially adjacent to each other, a simpler wiring for these portions can be provided.

In the configuration shown in FIG. 2, two separate reactor chambers are shown, separated by the shield portion. However, the various embodiments of the invention are not limited in this regard. In other embodiments, the reactors can share a common dielectric portion, where the dielectric portion includes a shield portion embedded or otherwise integrally formed within the common dielectric portion.

Additionally, the shield portion can be formed in several ways. For example, in some embodiments of the invention, the shield portion can be formed using a sheet or foil of electrically conductive material. For example, the sheet or foil can consist of a metal or metal alloy. However, the various embodiments of the invention are not limited to shield portions consisting of metallic conductors. Rather, non-metallic conductors can also be used without limitation. Further, the various embodiments are not limited to solely a sheet-type or foil-type shield portions. In some configurations, a perforated sheet or foil can also be used to provide the shield portion. In yet other configurations, the electrically conductive materials of the shield portion can be arranged to form a mesh or screen. In still other configurations, a plurality of shield portions can be used, each coupled to a reference voltage.

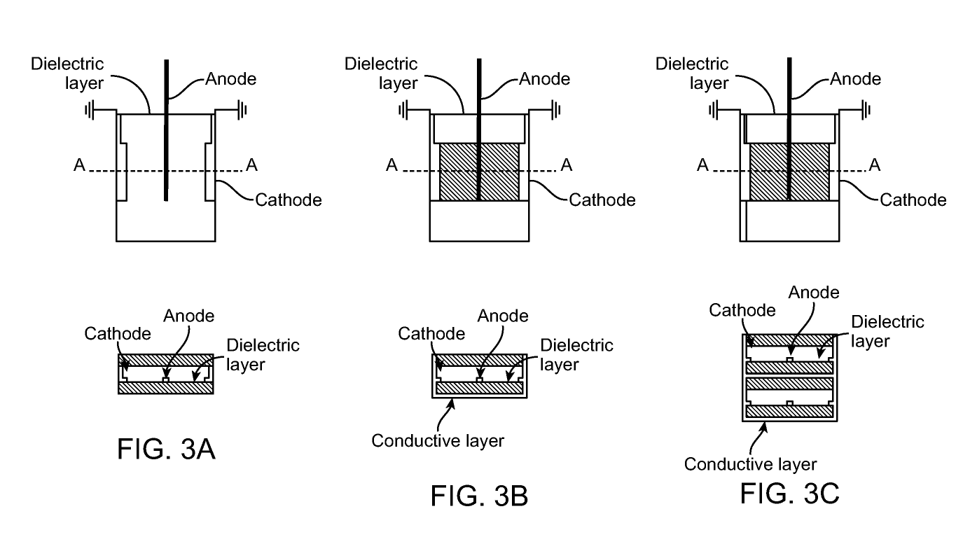

Although the shield portion will be useful for isolating various chambers, the shield portion also enhances performance of the discharge chambers, as described below with respect to FIGS. 3A, 3B, 3C, 4A, 4B, 5A, and 5B. In particular, the introduction of the shield portion enhances the generation of surface streamers in each chamber and thus contributes to the overall improvement in treatment efficiency of the various embodiments.

Referring first to FIG. 3A, there is shown top-down and cross section views (through cutline A-A) of a discharge chamber substantially similar to that illustrated in FIGS. 1A-1C. That is, the chamber in FIG. 2A consists of dielectric layers defining an enclosure, an anode electrode dispose on one of the dielectric layers, and cathode electrodes, running parallel to the anode electrode and coupled to a ground or reference voltage. FIG. 3B also shows top-down and cross section views (through cutline A-A) of a discharge chamber substantially similar to that illustrated in FIGS. 1A-1C, but including a conductive extending along an outer surface of the dielectric layer associated with the anode electrode and coupled to the cathode electrodes. When the discharge chamber of FIG. 3B is stacked on another, as shown in FIG. 3C, the conductive layer defines the shield portion discussed above.

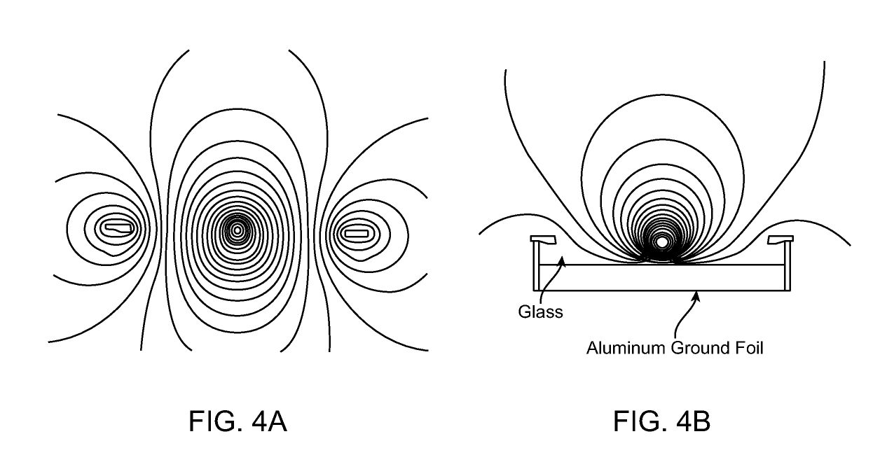

The introduction of this conductive layer or shield portion not only serves to isolate the discharge chambers, but also affects the development of electric fields within the discharge chambers. Referring now to FIGS. 4A and 4B, there are shown plots of electric potential distribution for the configurations of FIGS. 3A and 3B, respectively. As seen in FIG. 4A, the absence of the shield layer effectively causes the equipotential lines to spread out in space, similar to that seen for point charges. In contrast, FIG. 4B shows that the inclusion of the conductive layer significantly alters the distribution of the equipotential lines.

The shield confines the electric fields within the discharge chamber that has the following important beneficial effects: i) it allows operating stacked discharge chambers in parallel independent of each other, ii) the shield enhances the electric field at the edges of the anode that fosters the plasma channel initiation that results in higher density of plasma channels, iii) the electric field component normal to the dielectric is enhanced by the shield that keeps the plasma attached to the surface. The charged particles, particularly at the streamer head may accelerate to and strike at the dielectric surface due to the normal field component and result in further electron emission from the surface. The secondary electron emission from the surface may be supplemented by thermionic/photo-emission of electrons from the surface causing increased current flow through the plasma as observed. These effects explain higher power and broader range of voltage under which sliding discharges can be formed compared to pulsed corona discharges in air.

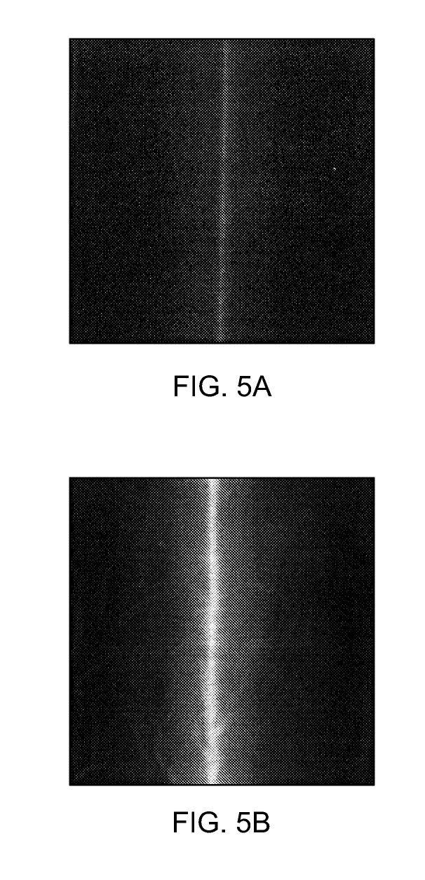

The result of the changes in the electric field is that the discharge in the discharge chambers can become more energetic and brighter, and thus more efficient for causing chemical reactions in the gases to be treated. The results of this are illustrated in FIGS. 5A and 5B. FIG. 5A is a photograph of the discharges in a discharge chamber similar to that in FIG. 3A. FIG. 5B is a photograph of the discharge in a discharge chamber similar to that in FIG. 3B. As can be seen from the photographs in FIGS. 5A and 5A, the introduction of the shield portion clear increases the density of surface streamers, thus increasing the energy density in the discharge chamber.

The higher energy density results in higher throughput relevant to industrial applications. Particularly, the increase in energy density without loss of efficiency for NO conversion reaction is a major advantage of the surface plasma compared to pulsed corona discharges in air where increase in energy density, e.g., by increasing peak voltage is usually accompanied by a significant loss of efficiency for NOx conversion.

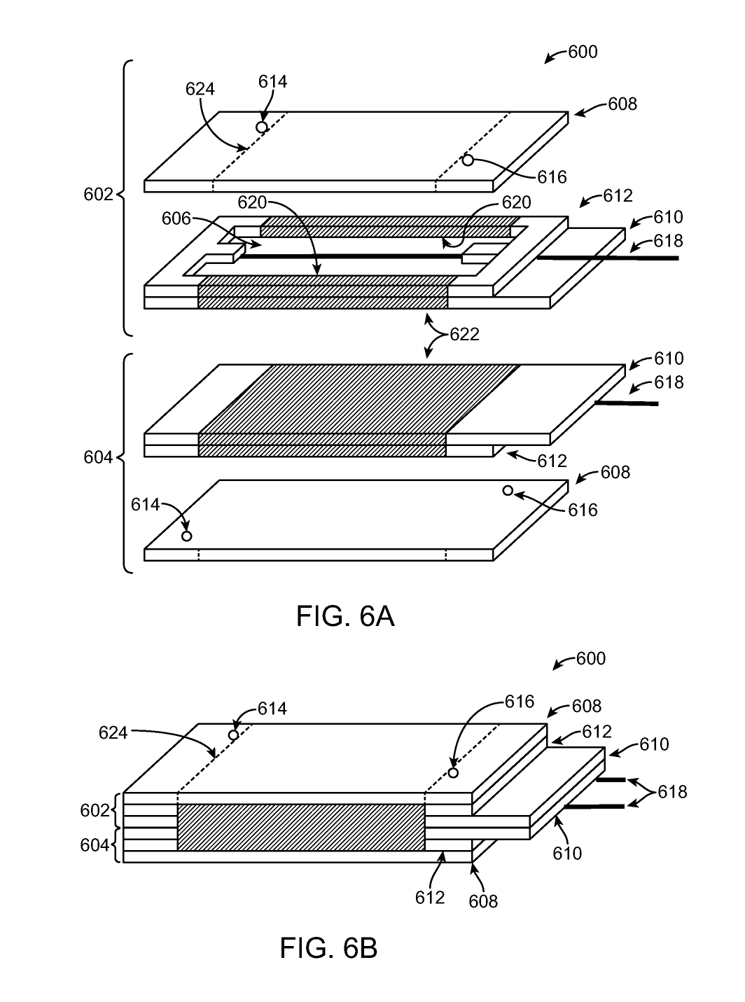

Referring now to FIGS. 6A and 6B, there is shown one exemplary configuration of a gas treatment device 600, arranged in accordance with an embodiment of the invention. FIG. 6A is a partially exploded view of device 600. FIG. 6B is an assembled view of device 600. As shown in FIGS. 6A and 6B, device 600 includes a first reactor 602 and a second reactor 604. Each of reactors 602 and 604 includes a discharge chamber 606, defined by a stack of layers. In particular, the stack includes a first dielectric layer 608, a second dielectric layer 610, and a spacer layer 612 disposed between dielectric layers 608 and 610.

In the configuration shown in FIGS. 6A and 6B, the stack of layers 608-612 can be formed using layers or sheets of dielectric materials, as described above with respect to FIG. 1. However, the various embodiments of the invention are not limited in this regarding and any other dielectric materials can be used for forming layers 608-612. To define discharge chamber 606, layers 608-612 are configured to provide an enclosure. In particular, dielectric layers 608 and 610 are configured to be substantially solid to provide upper and lower surfaces of such an enclosure. The side surfaces of the enclosure are provided by the spacer layer 612. In particular, spacer layer 612 includes an opening for defining the discharge chamber 606 between layers 608 and 612. Accordingly, by adjusting the size of the opening in spacer layer 612 and the thickness of spacer layer 612, the volume of discharge chamber 606 can be varied. Accordingly, as described above, this opening size and thickness can be selected to adjust the amount of surface- and volume-streamers for the discharge chamber.

Gas flow into the discharge chamber 606 can be provided using an inlet 614 and an outlet 616. In FIGS. 6A and 6B, the inlet 614 and the outlet 616 are shown as being incorporated into first dielectric layer 608. However, the various embodiments of the invention are not limited in this regard. Rather inlet 614 and outlet 616 can be formed in any of layers 608-612. Further the inlet 614 and outlet 616 of each of reactors 602 and 604 can be coupled to provide each serial or parallel communication of gases between the reactors 602 and 604. Such a communication can be provided using conduit or tubing portions (not shown).

However, gas communication between the reactors 602 and 604 is not limited to using conduit or tubing portions. For example, as shown in FIGS. 6A and 6B, reactors 602 and 604 are in a stacked configuration, where a second dielectric layer 610 of reactor 602 faces a second dielectric layer 610 of reactor 604. Accordingly, the reactors 602 and 604 can be configured to allow gas communication via respective ones of dielectric layer 610. In particular, dielectric layer 610 in each of reactors 602 and 604 can include any arrangement of openings such that when reactors 602 and 604 are stacked on each other, the discharge chamber 606 of reactors 602 and 604 are in gas communication. Accordingly, the use of conduits can be limited for purposes of directing a gas in or out of device 600.

In reactors 602 and 604, plasma streamers in a corresponding discharge chamber 606 are formed via anode electrode 618 and cathode electrodes 620. Although electrodes 618 and 620 are referred to as anode and cathode electrodes, respectively, this is for illustrative purposes only. In the various embodiments of the invention, these roles can be reversed, as described above with respect to FIGS. 1A and 1B. As shown in FIG. 6A, cathode electrodes 620 are formed by providing an electrically conductive surfaces along two facing sides of discharge chamber 606. In particular, an electrically conductive material is disposed on portions of spacer 612, such that two facing and substantially parallel electrodes are formed within discharge chamber 606. Anode electrode 618 is then formed using a wire extending across the opening in spacer layer 612, as shown in FIG. 6A. In particular, the wire for anode electrode 618 is disposed in discharge chamber 606 so that it extends substantially parallel and between to the cathode electrodes 620 formed on spacer layer 612. Further, the wire is disposed in discharge chamber 606 to provide an electrode that is substantially equidistant from each of cathode electrodes 620. That is, in a substantially wire-to-plate relationship. However, other relationships can be used in the various embodiments of the invention, as described above with respect to FIGS. 1A and 1B.

Although FIGS. 6A and 6B shows a wire for forming anode electrode 618, the various embodiments of the invention are not limited in this regard, as described above with respect to FIG. 1. In the various embodiments, the structure for anode electrode 618 can vary. Rather, any configuration that results in a greater electric field density at or near the anode electrode 618 as compared to cathode electrodes 620, can be used in the various embodiments of the invention. Accordingly, one or more pin-like or blade-like structures can also be provided to form anode electrode 618. Further, although the wire forming anode electrode 618 is shown as extending along the entire width or length of the opening in spacer layer 612, the various embodiments are not limited in this regard. In other configurations, a wire or blade-type structure for anode electrode 618 can extend only along a portion of the opening. In still other configurations, a series of wires, pin-type structures, or blade-type structures can be used over a portion or the entire length or width of the opening in spacer layer 612.

In operation, a voltage can be applied to anode electrode 618 via a portion of the wire forming anode electrode extending through spacer layer 612. However, alternatively or in addition to such a wire portion, spacer layer 612 or other portions of reactors 602 and 604 can be configured to include any type of connector structure for providing a voltage for anode electrode 618. Thus, such structures can be disposed on or extend through one or more portions of any of layers 608, 610, and 612. Similarly, a voltage can be applied to cathode electrodes 620 via a portion of the electrically conductive surfaces extending to outer surfaces of spacer layer 612. Thus, alternatively or in addition to such portions, spacer layer 612 or other portions of reactors 602 and 604 can be configured to include any type of connector structure for providing a voltage for cathode electrodes 620. Preferably, dielectric isolation can be provided between the anode electrode 618 for reactors 602 and 604. For example, as shown in FIGS. 6A and 6B, portions of dielectric layer 610 can extend along a length of anode outside the discharge chamber 606. Thus, such structures can also be disposed on or can also extend through one or more portions of any of layers 608, 610, and 612.

To provide decoupling between reactors 602 and 604, a shield portion for the device 600 can be formed by providing a electrically conductive portion between inner dielectric layers 610 and thereafter connecting this shield portion to a reference or ground voltage, as described above. However, as shown in FIGS. 6A and 6B, for each of reactors 602 and 604, a shield portion 622 is provided that is electrically connected to the cathode electrodes 620 of a corresponding one of reactors. Thus, a single voltage can be provided for the shield portion 622 and cathode electrodes 620 for the reactors 602 and 604 in device 600. Thus reduces requirements and complexity for a circuit providing power to device 600.

Additionally, to further reduce wiring requirements for device 600, the shield portion 622 and cathode portions 620 can be configured in each of reactors 602 and 604 so that the assembling of device 600 automatically electrically connects these portions in reactors 602 and 604. For example, as shown in FIG. 6A, shield portion 622 is disposed on an outer surface of second dielectric layer 610 in each of reactors 602 and 604. Thus, when device 610 is assembled as shown in FIG. 6B, the shield portion 622 of reactor 602 is placed in physical and electrical contact with the shield portion 622 of reactor 604. Accordingly, if a reference of ground voltage is applied to shield portion 622 or either of cathode electrodes 620 in reactor 602 or reactor 604, all of these portions in both of reactors 602 and 604 are biased to the same reference voltage. In the some embodiments of the invention, the reference voltage can be a ground potential. However, the invention is not limited in this regard and the reference voltage can be any voltage suitable for electrodes 620. That is, at least the voltage difference provided between electrodes 618 and 620 should be provided between electrode 618 and shield portion 622.

In the various embodiments, the connection between shield portion 622 and cathode electrodes 620 can be provided in various ways. In some configurations, electrically conductive wires and/or any other types of electrically conductive elements or structures can be used to provide the connection. In the configuration shown in FIGS. 6A and 6B, this connection is provided by forming shield portion 622 and cathode electrodes 620 using a continuous electrically conductive portion, such as an electrically conductive foil or sheet. In such configurations, foil or sheet can be configured as follows. First, a foil or sheet can be provided, with first and second ends that extend along the outer surface of second dielectric layer 610 that corresponds to at least discharge chamber 606. The first end of the foil or sheet can be wrapped around a first side portion of spacer layer 612 and the second end can be wrapped around a second side portion of spacer layer 612 facing the first side portion. As a result, a single electrically conductive portion, extending along the outer surface of each of reactors 602 and 604 defines both the shield portion 622 and cathode electrodes 620.

In some configurations, the shield portion 622 can optionally extend around each of reactors 602 and 604. For example, in some configurations, an additional shield portion 624 can be formed on an exterior surface of outer dielectric layer 608. In operation, the additional shield portion 624 can then be coupled to the cathode electrodes 620 and shield portion 622. In another configuration, the additional shield portion 624 for reactors 602 and 604 can be formed by wrapping another foil or sheet around the assembled chambers, i.e., around the outer sides of layers 608 as well as around the sides of the chambers. In such a configuration, the foil defining additional shield portion 624 can be wrapped so as to make electrical contact with electrodes 620 on the sides of the chambers 602 and 604, and thus electrically couple shield portion 622 to shield portion 624.

Such a configuration provides improved performance, in particular as compared to a single reactor system, such as that described in FIGS. 1A and 1B. In particular, where a test reactor was constructed in accordance with FIGS. 6A and 6B and with an additional shield portion 624 for reactors 602 and 604, the present inventor has found that the electrical power consumed in the plasma in such a system was 0.33 W. In contrast, the present inventors have found that electrical power consumed in the plasma was 0.028 W in the case of a cleaning device configured in accordance with the single reactor configuration illustrated in FIGS. 1A and 1B and having similar dimensions, a ˜10× increase. The power (P) was calculated by the following formula: P=(∫VI dt)f. The voltage pulse was the same in the two cases, with a peak voltage value of ˜30 kV, and the pulse frequency ˜10 Hz was also the same. Thus, the increase in power is due to corresponding increase in current flowing through the discharge gap during the pulse when the shield portion extends around the discharge chambers. The higher power is beneficial as it results in higher amount of pollutant destroyed in the plasma.

In the various embodiments, the shield portion 622 and electrodes 620 are generally described as being held at the same voltage, different from the voltage at electrode 618. That is, using only two voltages overall. However, the various embodiments are not limited in this regard. Rather, the voltages at each of electrode 618, electrodes 620, and shield portion 622 can be different.

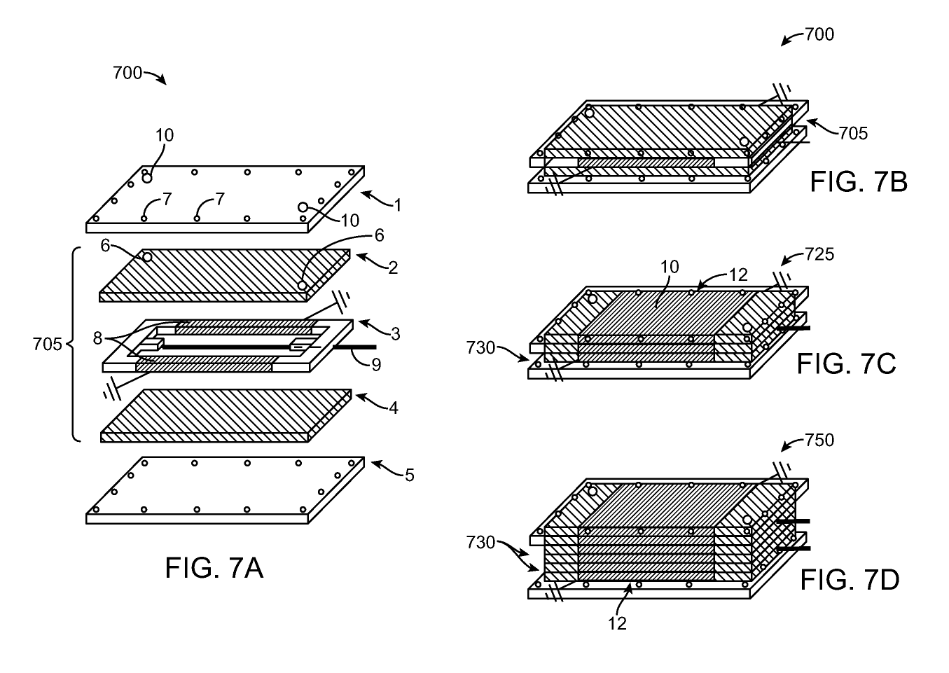

The various embodiments described above thus allow a wide range of flexibility in designing and constructing a gas treatment device. Thus, depending on the efficiency requirements, various configurations can be utilized in the various embodiments. These are summarized with respect to FIGS. 7A-7D.

Turning first to FIG. 7A, there is shown an exploded view of a single chamber treatment device 700 in accordance with an embodiment of the invention. Similar to the devices described with respect to FIGS. 6A and 6B, the device 700 can include a spacer layer 3 with a first electrode 9 coupled to a power supply and a second electrodes 8 coupled to a ground or reference voltage. As also described above with respect to FIGS. 6A and 6B, device 700 can include an first dielectric layer 2 and a second dielectric layer 4 with the spacer layer 3 positioned in between. At least one of dielectric layers 2 and 4 can include inlet/outlet ports for a gas to enter and exit the discharge chamber 705 defined the dielectric layers 2 and 4 and spacer layer 3. Additionally, the device 700 can include enclosure plates 1 and 5. The enclosure plates 1 and 5 can include openings 7 for fasteners (not shown) to apply a force between enclosure plates 1 and 5 and thus clamp the dielectric layers 2 and 4 and spacer layer 3 together to form the discharge chamber 705. A sealant, such as silicone, rubber, or the like, can be used between the components to ensure a tight seal of the discharge chamber 705. Either of enclosure plates 1 and 5 can also include inlet/outlet ports 10, which coincide with ports 6 to allow gas to enter and exit the device 700. FIG. 7B shows a view of device 700 once assembled. This device thus corresponds to the configuration of FIG. 3A.

As noted above, a shield portion can be added to the configuration of FIG. 3A. This is illustrated in FIG. 7C. FIG. 7C shows an assembled view of another single chamber treatment device 725 in accordance with another embodiment of the invention. In this configuration a conductive layer or shield portion 12 is provided on the exterior surfaces of dielectric layers 2 and 4 to electrically and physically couple electrodes 8. Thus, the shield portion 12 and electrodes 8 are coupled to a same ground or reference voltage to define a shielded discharge chamber 730. As shown in FIG. 7C, this can be accomplished by wrapping a conductive sheet around dielectric layers 2 and 4 and spacer layer 3. Alternatively, the conductive sheet can be placed on at least one of dielectric layers 2 and 4 and can be positioned such that when device 725 is assembled, the conductive sheet is in contact with electrodes 8. This device thus corresponds to the configuration of FIG. 3B.

A third configuration is shown in FIG. 7D. FIG. 7D shows an assembled view of a multi-chamber treatment device 725 in accordance with an embodiment of the invention. In this configuration, two or more of the discharge chambers 730 of FIG. 7C can be stacked and sandwiched between enclosure plates 1 and 5. In this configuration, the shield portions can be located around each discharge chamber 730. Alternatively, the shield portion can be provided at least between the discharge chambers 730. In such a configuration, one could instead use two of discharge chambers 705 and place the conductive shield portion therebetween.

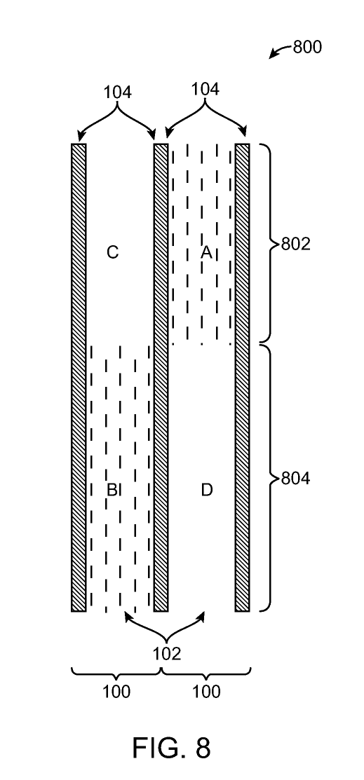

In the exemplary embodiments describe above, the coupling between the first and second reactors is reduced or eliminated by providing a shield portion therebetween. However, the various embodiments of the invention are not limited in this regard. As described above, the principal difficulty in generating plasma in two adjacent chambers is the induction of charges on a dielectric surface of a reactor adjacent to another reactor in which a plasma is being formed. Accordingly, another embodiment of the invention involves forming plasma in adjacent chambers, without a shield portion therebetween, that fails to induce charges on neighboring dielectric layers. Accordingly, another aspect of the invention provides for plasma formation using a staggered-discharge approach. That is, the adjacent reactors are configured such that the discharge for forming plasma in a first reactor and the discharge for forming plasma in a second, adjacent chamber reactor occur in non-overlapping portions. This is conceptually illustrated with respect to FIG. 8.

FIG. 8 is a partial cross-section diagram of another exemplary configuration for a gas treatment device 800 in accordance with an embodiment of the invention. In particular, FIG. 8 is a stacked arrangement of two of system 100 (reactors 100A and 100B), where the cross section shown in FIG. 8 is a portion of the cross-section along cutline 2-2 in FIG. 1 for each of reactors 100A and 100B. Each of reactors 100A and 100B are configured substantially similar to system 100 in FIG. 1. Thus, the partial cross-section of device 800 shows the top and bottom dielectric portions 104A and 104B for each of reactors 100A and 100B, respectively, that defines respective ones of discharge chambers 102A and 102B. In device 800, the decoupling between reactors 100 is provided by staggering the portions of each discharge chamber in device 800 that are to be discharged.

This staggering can be provided in several ways. For example, in one configuration, the electrodes 110 and 112 in each discharge chamber 102 can be configured such that when device 200 is assembled, the electrodes that are being biased at the same time do not substantially overlap. For example, as shown in FIG. 8, only the electrodes associated with an upper portion 802 in a first system 100 and the electrodes associated with a lower portion 804 in a second system 100 are configured to provide a plasma in portions “A” and “B” in device 200. Thus, any charges induced in an adjacent discharge chamber not induced in a portion of the discharge chamber associated with generation of plasma. That is, the charges induced in portion “C” of the second system 100 by the plasma in portion “A” of first system 100 are inconsequential, since the plasma in second system 100 is limited to portion “B”. Similarly, the charges induced in portion “D” of the first system 100 by the plasma in portion “B” of second system 100 are inconsequential, since the plasma in first system 100 is limited to portion “A”. However, in such a configuration, since only a portion of the volume of each discharge chamber is used, the cleaning efficiency may be reduced.

In some configurations overlapping portions can be provided by controlling a timing of discharges in device 800. In particular, the timing associated with biasing of the electrodes for these portions can be controlled so that only non-overlapping portions are biased at the same time. Thus, at any one time, only one set of electrodes, associated with non-overlapping portions, are concurrently biased. Such a configuration is advantageous, since switching between the different sets of non-overlapping electrode portions permits a majority of the volume of each discharge chamber 102 in device 800 to be used. Accordingly, a greater cleaning efficiency can be achieved.

### EXAMPLES

The following non-limiting Examples serve to illustrate selected embodiments of the invention. It will be appreciated that variations in proportions and alternatives in elements of the components shown will be apparent to those skilled in the art and are within the scope of embodiments of the invention.

The parallel operation of two plasma reactors shown in FIG. 2 was evaluated with respect to a single reactor. These reactors were configured substantially similar to the embodiment illustrated in FIG. 3. These reactors were configured as follows:

Outer dielectric layer—acrylic sheet (21.6 cm×12.7 cm×0.6 cm);

Inner dielectric layer—acrylic sheet (24.1 cm×12.7 cm×0.6 cm);

Spacer layer—acrylic sheet (21.6 cm×12.7 cm) with opening (16.5 cm×7.6 cm);

Anode electrode—stainless steel wire (150 μm diameter×12.7 cm length);

Cathode electrode/Shield portion—aluminum foil (12.7 cm wide);

Peak voltage—30 kV at ˜10 Hz; and

Gas flow rate—˜1 liter/minute.

In the various tests performed by the inventors, the thickness of the spacer layer was varied between 2 mm and 14 mm.

Based on the testing of reactors configured as described above, the present inventors have found that for a two reactor configuration, as in FIGS. 6A and 6B, such configuration provides the necessary decoupling, as plasma was readily generated in each of the chambers. The input power was also found to increase to 1.5 times to 2 times as compared with a single reactor. In the two reactor configuration, as in FIG. 3 in the absence of the shielding 622, the input power was almost the same as in a single reactor operation and the input power was about ten times lower as compared with the case of presence of the shielding 622. As described above, increased power correlates to higher cleaning efficiency.

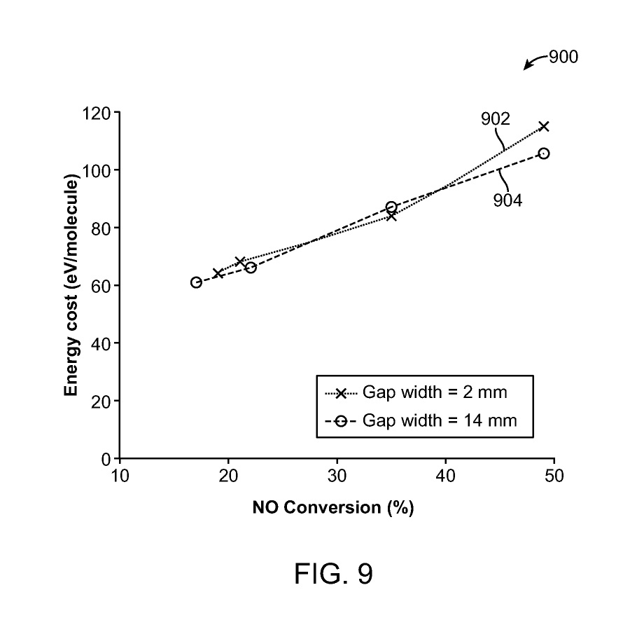

Referring now to FIG. 9, there is shown an x-y plot 900 of energy cost (eV/molecule) as a function of NO conversion %, for a gas treatment device configured in accordance with FIGS. 6A and 6B and dimensioned as described above. The data in FIG. 9 shows NO to NO₂ conversion when one of the two reactors was operated and gap width was varied between the two dielectric layers enclosing the plasma. The data associated with a gap width of 2 mm is shown by curve 902 (“X”) and the data associated with a gap width of 14 mm is shown by curve 904 (“O”). The data associated with these curves is shown below in Table 2:

TABLE 2
Effect of width between dielectric layers (Width)

| Gap Width | Initial | NO Conver- | Energy Cost |
|---|---|---|---|
| (mm) | NO (ppm)* | sion (%) | (eV/molecule) |
| 2 | 747 | 19 | 64 |
| 2 | 607 | 21 | 68 |
| 2 | 279 | 35 | 84 |
| 2 | 164 | 49 | 115 |
| 14 | 755 | 17 | 61 |
| 14 | 565 | 22 | 66 |
| 14 | 280 | 35 | 87 |
| 14 | 164 | 49 | 106 |

*Nitrogen mixed with NO at flow rate of 1 Liter/min.

For the bias conditions and input flow rates used for generating the data in Table 2 and FIG. 9, input power was found the same in the two cases. Further, a same flow rate of the treated gas was employed. As shown in Table 2 and FIG. 9, the energy cost for NO to NO₂ conversion was approximately the same despite the variation in gap width. Accordingly, these results show that the size of the plasma reactors can be reduced by reducing the gap width between dielectric layers without affecting the flow rate or conversion of the pollutant in the treated gas. Such compact sizes for the plasma reactors are desirable for their commercial applications, particularly in mobile sources of polluted gases, such as NOx emissions from vehicles.

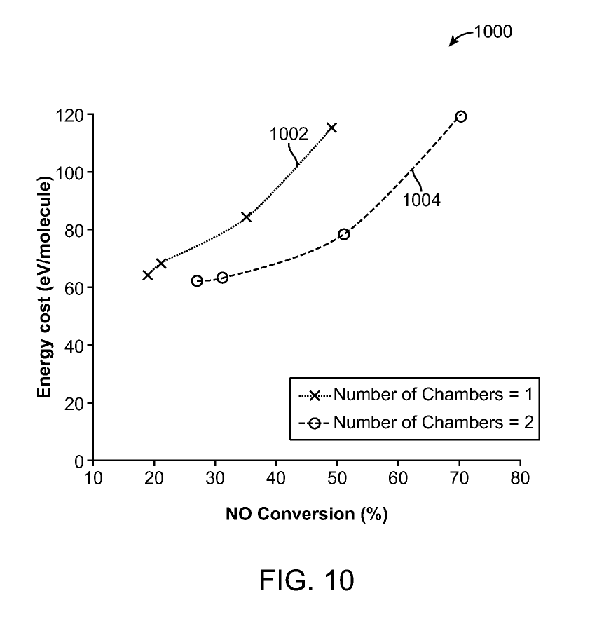

Referring now to FIG. 10, there is shown an x-y plot 1000 of energy cost (eV/molecule) as a function of NO conversion %, for a gas treatment device configured in accordance with FIGS. 6A and 6B, with a gap width of 2 mm, and dimensioned as described above. The data in FIG. 10 shows NO to NO₂ conversion when one or two reactors was operated. The data associated with operation of a single reactor is shown by curve 1002 (“X”) and the data associated with operation of two reactors is shown by curve 1004 (“O”). For the two reactor configuration, the two reactors were operated in series. That is, the treated gas from first reactor was fed to the second reactor for further treatment The data associated with these curves is shown below in Table 3:

TABLE 3
Comparison of a single surface plasma reactor and
two surface plasma reactors operating in series

| No of | Initial | NO Conver- | Energy Cost |
|---|---|---|---|
| Chambers | NO (ppm)* | sion (%) | (eV/molecule) |
| 1 | 747 | 19 | 64 |
| 1 | 607 | 21 | 68 |
| 1 | 279 | 35 | 84 |
| 1 | 164 | 49 | 115 |
| 2 | 752 | 27 | 62 |
| 2 | 607 | 31 | 63 |
| 2 | 283 | 51 | 78 |
| 2 | 164 | 70 | 119 |

*Nitrogen mixed with NO at flow rate of 1 Liter/min.

Again, as in the previous data set, similar bias conditions and input flow rates were employed. However, FIG. 10 and Table 3 show that the overall energy cost for NO to NO₂ conversion was decreased significantly for the two reactor configuration. For example, for about ˜50% NO conversion the reduction in energy cost was about 30%. The decrease in energy cost in the case of the two reactor configuration is believed to be due to the fact that some of the reactive species that could not be utilized in the first reactor became activated and was utilized in the second reactor. For example, surplus O₃ from first reactor may decompose and produce additional reactive oxygen radicals in the second reactor. Accordingly, for a substantially similar energy cost, a 40% to 50% improvement in NO conversion is observed. Therefore, the advantage of utilizing a two chamber system is clearly shown.

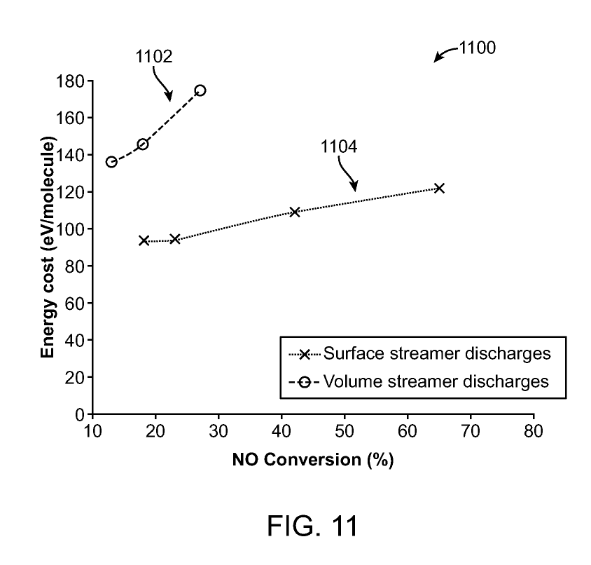

Referring now to FIG. 11, there is shown an x-y plot 1100 of energy cost (eV/molecule) as a function of NO conversion %, for a gas treatment device configured to operate in surface-streamer mode and compared with a device configured to operate in volume-streamer mode. The device that operated in surface-streamer mode was configured in accordance with FIGS. 6A and 6B, with a gap width of 2 mm, and dimensioned as described above. The device that operated in volume-streamer mode was configured according to dimensions shown in Table 1, reactor number 4. That is, a cylindrical or coaxial plasma reactor. The data in FIG. 11 shows NO to NO₂ conversion from a 5:95 oxygen/nitrogen mixture. The data associated with operation in a surface-streamer mode is shown by curve 1104 (“X”) and the data associated with operation in a volume-streamer mode is shown by curve 1102 (“O”). The device configured according to FIGS. 6A and 6B for operation in surface-streamer mode, the two reactors were operated in series. That is, the treated gas from first reactor was fed to the second reactor for further treatment. The data associated with these curves is shown below in Table 4:

TABLE 4
Comparison of surface-streamers in two chambers
operating in series with volume streamers in
a Coaxial reactor, in presence of 5% Oxygen

| | Initial NO | NO Conver- | Energy Cost |
|---|---|---|---|
| Reactor | (ppm)* | sion (%) | (eV/molecule) |
| Surface-streamer Discharges | 794 | 18 | 93 |
| Surface-streamer Discharges | 650 | 23 | 94 |
| Surface-streamer Discharges | 316 | 42 | 109 |
| Surface-streamer Discharges | 186 | 65 | 122 |
| Volume-streamer Discharges | 794 | 13 | 136 |
| Volume-streamer Discharges | 565 | 18 | 146 |
| Volume-streamer Discharges | 331 | 27 | 175 |

*Oxygen 5%, balance Nitrogen and mixed with NO at flow rate of 1 Liter/min.

Again, as in the previous data sets, similar bias conditions and input flow rates were employed. As shown in Table 4 and FIG. 11, the reactor configuration using surface-streamer discharges is significantly more energy efficient than the reactor configuration using volume-streamer discharges for NO to NO₂ conversion. In particular, for substantially similar amounts of NO conversion, at least a 35% reduction in energy cost is observed.

In addition to the foregoing tests and analyses, a study evaluating the performance of the treatment systems in accordance with the various embodiments was performed. Each of treatment systems for this study consisted of a substantially rectangular reactor with similar electrode configurations so as to allow a more meaningful comparison between the treatment systems.

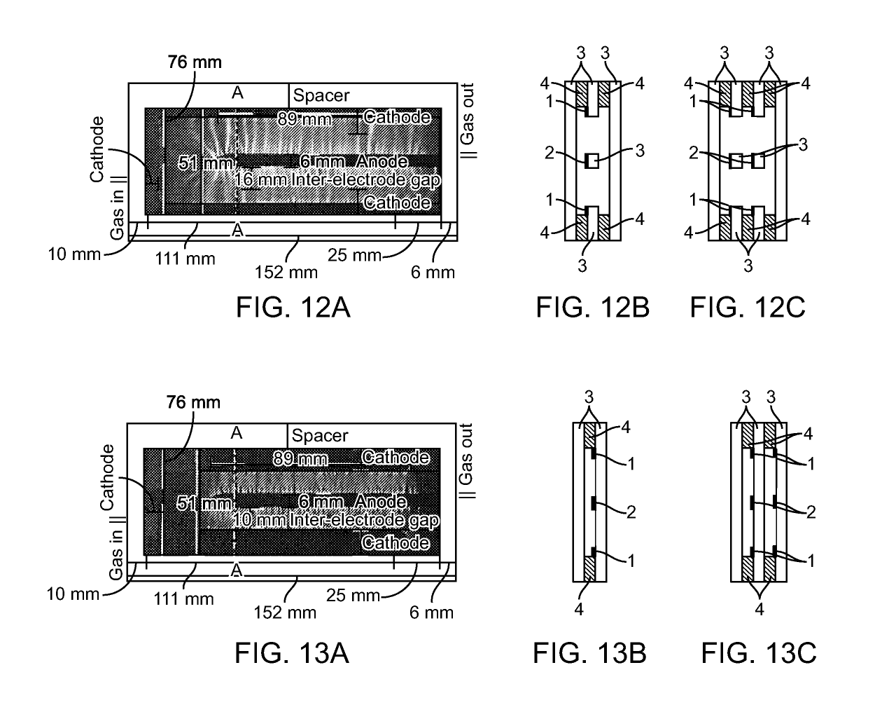

A first type of system evaluated in this study is shown in FIGS. 12A, 12B, and 12 C. FIGS. 12A, 12B, and 12C show views of a non-thermal plasma treatment system in which the plasma discharges consist of pulsed corona discharges in air. This reactor was configured to provide the same plasma as in the case of Reactor 4 in Table 1, but with a rectangular shape instead of a cylindrical shape. FIG. 12A is a top view illustrating the various dimensions and spacing for electrodes and other components therein. FIG. 12B is a cross section of the system of FIG. 12A, along cutline A-A for a single electrode assembly. FIG. 12B is a cross section of the system of FIG. 12A, along cutline A-A for two stacked electrode assemblies. In FIGS. 12A-12C, 1 is the cathode, 2 is the anode, 3 is a dielectric layer made of window glass of 2.4 mm thickness, and 4 is a spacer made of silicon rubber of 15 mm thickness. Electrodes (1 and 2) were made of aluminum foil of 50 μm thickness with acrylic adhesive to paste them on the dielectric layers 3.

A second type of system is shown in FIGS. 13A, 13B, and 13C. FIGS. 13A, 13B, and 13C show views of a non-thermal plasma treatment system in which the plasma discharges consist of sliding discharges, but with no shields. In other words, this reactor was configured to provide the same plasma as in the case of FIG. 3A. FIG. 13A is a top view illustrating the various dimensions and spacing for electrodes and other components therein. FIG. 13B is a cross section of the system of FIG. 13A, along cutline A-A for a single electrode assembly. FIG. 13B is a cross section of the system of FIG. 13A, along cutline A-A for two stacked electrode assemblies. In FIGS. 13A-13C, 1 is the cathode, 2 is the anode, 3 is a dielectric layer made of window glass of 2.4 mm thickness, 4 is a spacer made of silicon rubber of 2.4 mm thickness. Electrodes (1 and 2, respectively) were made of aluminum foil of 50 μm thickness with acrylic adhesive to paste them on the dielectric layers 3.

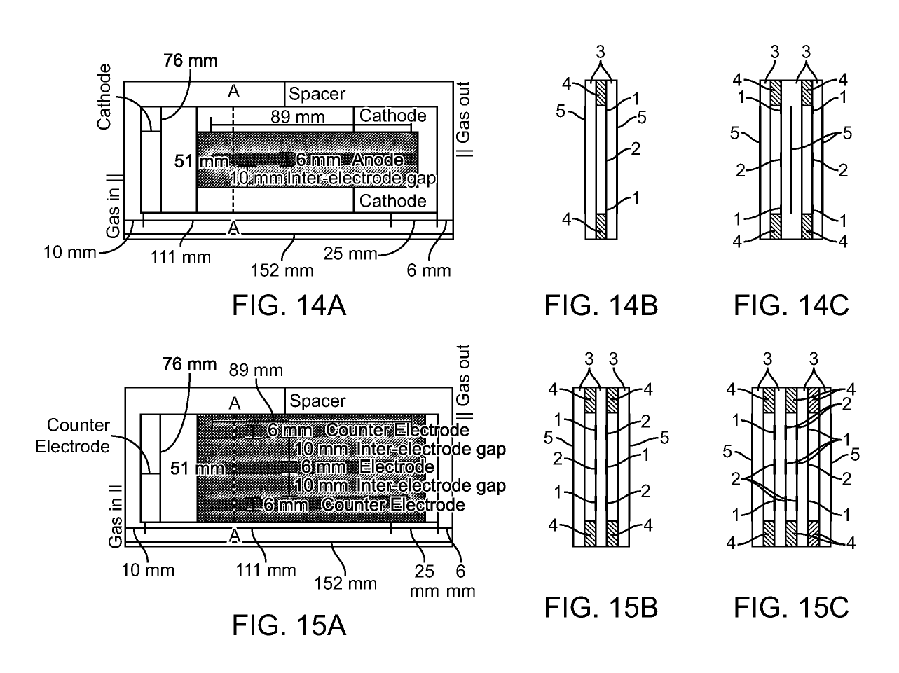

A third type of system is shown in FIGS. 14A, 14B, and 14C. FIGS. 14A, 14B, and 14C show views of a non-thermal plasma treatment system in which the plasma discharges consist of shielded sliding discharges in accordance with the various embodiments of the invention. In other words, this reactor was configured to provide the same plasma as in the case of FIG. 3B. FIG. 14A is a top view illustrating the various dimensions and spacing for electrodes and other components therein. FIG. 14B is a cross section of the system of FIG. 14A, along cutline A-A for a single electrode assembly. FIG. 14B is a cross section of the system of FIG. 14A, along cutline A-A for two stacked electrode assemblies. In FIGS. 14A-14C, 1 is the cathode, 2 is the anode, 3 is a dielectric layer made of window glass of 2.4 mm thickness, 4 is a spacer made of silicon rubber of 2.4 mm thickness, and 5 is the shield (kept at cathode potential). Electrodes and the shield (1, 2, and 5, respectively) were made of aluminum foil of 50 μm thickness with acrylic adhesive to paste them on the dielectric layers 3.

A fourth type of system is shown in FIGS. 15A, 15B, and 15C. FIGS. 15A, 15B, and 15C show views of a non-thermal plasma treatment system in which the plasma discharges consist of plasma enhanced sliding discharges in accordance with the various embodiments of the invention. FIG. 15A is a top view illustrating the various dimensions and spacing for electrodes and other components therein. FIG. 15B is a cross section of the system of FIG. 15A, along cutline A-A for a single electrode assembly. FIG. 15B is a cross section of the system of FIG. 15A, along cutline A-A for two stacked electrode assemblies. In FIGS. 15A-15C, 1 is the cathode, 2 is the anode, 3 is a dielectric layer made of window glass of 2.4 mm thickness, 4 is a spacer made of silicon rubber of 2.4 mm thickness, and 5 is the shield (kept at cathode potential). Electrodes and the shield (1, 2, and 5, respectively) were made of aluminum foil of 50 μm thickness with acrylic adhesive to paste them on the dielectric layers 3.

In the case of FIGS. 15A-15C, both anode and cathode electrodes result in streamers or plasma channels that propagate towards each other and merge in the middle of the discharge gap. In this configuration, there is a cathode 1 on one side of dielectric 3 there is anode 2 on the same location on the other side of the dielectric 3 and vice versa. That is, the anode 2 and the cathode 1 for different chambers are co-located. As a result, the streamers on one side of the dielectric 3 would have an opposite polarity as compared to the streamers on the other side of the dielectric 3. As a result, the streamers on one side of dielectric 3 become electrically coupled with the streamers at the same location on the other side of the dielectric layer 3. However, the coupled streamers are of opposite polarity and they will electrically enhance each other rather than having a prohibitive effect, as previously discussed with respect to FIGS. 1A-1C. As a result, in such a configuration, a shield portion may not be needed for forming, operating, or scaling this type of reactor configuration. A shield portion may still be required in this configuration to stop electromagnetic emissions from the plasma reactor that might interfere with any nearby electronic equipment. However, this can be a general shielding of the reactor, not the chamber by chamber shielding of FIGS. 14A-14C.

For each of the systems described above, positive high voltage pulses were applied to the anodes while the shield and/or cathodes were maintained at a ground voltage. Applying positive high voltage pulses of short rise time and short duration to center strip (anode 2) resulted in the forming of thin plasma channels (streamers) distributed along the anode and propagating towards cathode in the electrode assembly. This is shown in FIG. 12A.

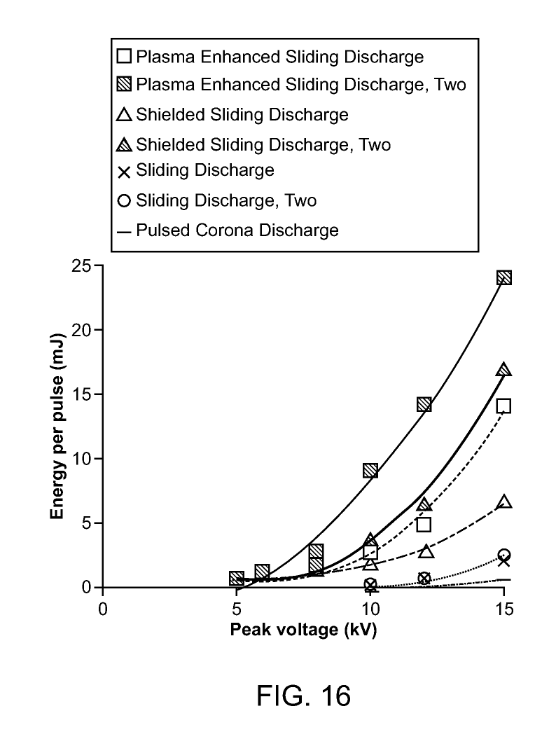

The addition of a dielectric layer beneath the electrodes, as in FIGS. 13A-13C, makes the streamers slide at the solid/gas interface, i.e., producing sliding discharges in the electrode assembly, as shown in FIG. 13A. In this case, the plasma generates a positive surface charge on the dielectric surface and consequently increases the normal component of the electric field that keeps the plasma attached to the surface. Likely, secondary electron emission due to energetic ions, metastable particles and/or photons striking at the surface, especially close to streamer head, account for the increase in electrical current which results in increase in energy per pulse. This enhancement is as shown in FIG. 16. FIG. 16 is a plot of energy per pulse versus peak voltage curves for different type of plasmas formed in the reactors shown in FIGS. 12A-15C.

However, the increase of the normal component for the configuration of FIGS. 13A-13C is still less than in the case where the cathodes are connected by a conductive layer on the back side of the dielectric layer. For example, in the case of the electrode assembly of FIGS. 14A-14C, shielded sliding discharges are provided, which result in a further increase in energy per pulse, as shown in FIG. 16. In this case, even without surface charge, the electrode arrangement causes a strong increase in the component normal to the surface of the dielectric that can be inferred from modeling of the electric field in such an electrode configuration as shown in FIGS. 4A and 4B. The effect is strongest at the edge of the central electrode where the electric field intensity is highest. This fosters the ignition of breakdown and then keeps the plasma channels firmly attached to the surface. It explains significant increase in current flowing through shielded sliding discharges compared to pulsed corona discharges and sliding discharges, which is reflected in the corresponding increase in energy per pulse as shown in FIG. 16.

As previously described, when two electrode assemblies are operated in parallel, the electric fields and the charges from plasma of one assembly interfere with and suppress plasma formation in the neighboring assembly and vice versa. It explains why FIG. 16 shows that energy per pulse could not be increased when two parallel electrode assemblies were operated in the case of pulsed corona discharges (FIG. 12C) or in stacked discharge chambers in the case of sliding discharges (FIG. 13C) in this study. As discussed above, the shield decouples the plasmas in the two stacked discharge chambers and provides the increase in energy per pulse proportionate to the number of discharge chambers, as shown in FIG. 16 for the configurations of FIG. 14C.

In the case of sliding discharge reactor of FIG. 13C, when electrodes on one side of dielectric layer were copied on the other side of the dielectric and operated in parallel, the energy per pulse remained almost the same as for one set of electrodes on one side of the dielectric layer. It is due to the prohibitive effect of the coupling of the two plasmas formed in the two set of electrodes, as explained earlier. The present study revealed that the situation can be reversed, i.e., plasma enhanced sliding discharges can be formed when the electrodes on one side of the dielectric layer are copied on the other side but rotated at 180°, such that the anode on one side of the dielectric becomes cathode on the other side and vice versa as shown in FIG. 15B. In this case, the electrical charges and the electric fields due to cathode-directed streamers on one side of the dielectric promote the opposite polarity plasma, i.e., anode-directed streamers on the opposite side of the dielectric and vice versa. Such opposite polarity streamers appear to couple with each other and propagate as minor image of each other on the opposite sides of the dielectric layer. The energy per pulse increased about three times relative to sliding discharges. The plasma was not confined to inter-electrode gap, but distributed all around anode as well as cathode and there was a 3^{rd} bright zone in the middle of the inter-electrode gap as shown in FIG. 15A. The bright zone around the anode was most likely due to cathode-directed streamers and that around cathode due to anode-directed streamer. The opposite polarity streamers on the same side of dielectric from electrodes facing each other, merged in the middle of the discharge gap where ionic reactions between opposite charges produced excited states the de-excitation of which emitted photons forming the 3^{rd} bright zone in the middle of the discharge gap.

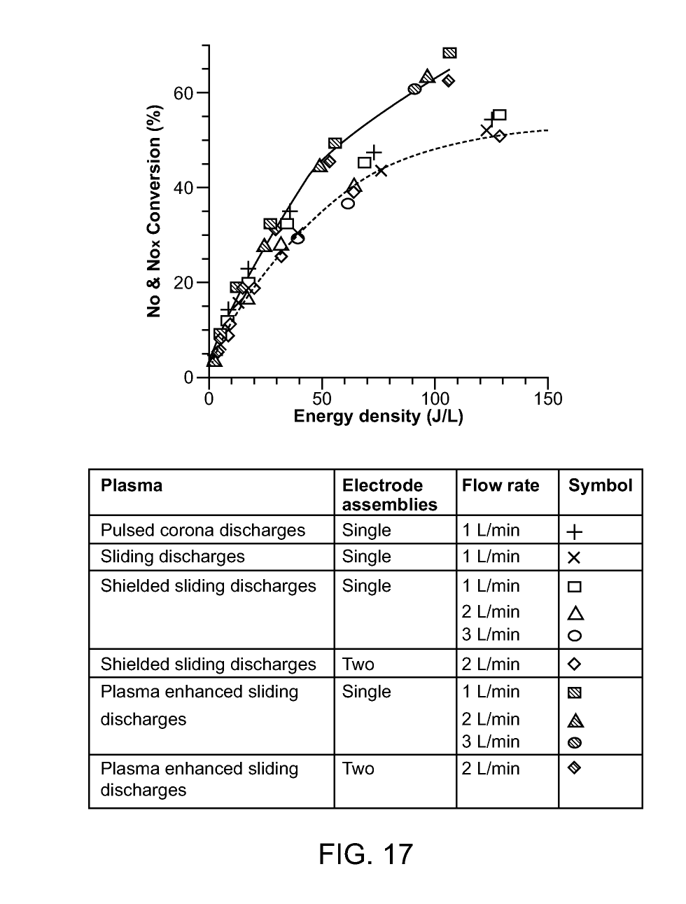

The efficiencies of the plasma reactors of FIGS. 12A-15C were compared by evaluation of NO conversion in air. These results are shown in FIG. 17. FIG. 17 is a plot of NO conversion versus specific input energy curves in the different treatment systems of FIGS. 12A-15C. The peak voltage was ˜15 kV and the inter-electrode gap was 10 mm, except for pulsed corona discharges where the plasma formation was limited only around the rounded end portion of the anode under these conditions. So, for the case of pulsed corona discharges the peak voltage was increased to ˜25 kV and the inter-electrode gap was increased to 16 mm to form the plasma all along the effective length of the electrode as shown in FIG. 12A. Varying pulse repetition rate in the range of 1 Hz to 500 Hz varied the power in the plasma.

The NO removal was almost identical in the case of pulsed corona discharges, sliding discharges, and shielded sliding discharges, but higher in the case of plasma enhanced sliding discharges at the same energy density (specific input energy) as shown in FIG. 17. Apparently two factors are responsible for the better efficiency of plasma enhanced sliding discharges compared to the other plasmas in this study. The first factor is that the plasma spreads over a larger area on the electrode assembly which minimizes the diffusion limitations between chemically active species produced in the plasma and their target that is NO molecules in the ambient gas in the case of plasma enhanced sliding discharges compared to other plasmas in this study. The second factor is that the range and the proportion of the chemically active species might be broader and more favorable for NO conversion compared to other plasmas because both the cathode-directed and anode-directed sliding discharges are formed simultaneously.

The invention also includes the method of treating a gas in a plasma reactor discharge chamber using the above principles. This method involves the steps of applying the gas to a discharge chamber, in which is generated a pulsed corona discharge where the formation of volume-streamers is inhibited, so that surface-streamers play an increasing role in energy density within the discharge chamber.

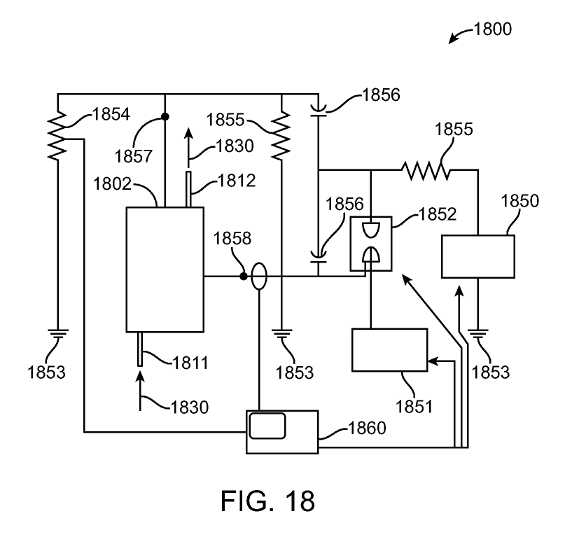

FIG. 18 illustrating a system including a gas treatment device 1802, configured in accordance with an embodiment of the invention, and supporting electrical circuitry. In operation, a high voltage pulse can be applied to device 1802. In the various embodiments, the pulse can be formed using an L-C inversion circuit, with trigger generator 1851, spark gap switch 1852, resistor 1855, capacitors 1856, and high voltage direct current power supply 1850. This pulse was applied to high voltage electrode node 1857 (i.e., the anode electrode), while counter electrode node 1858 (i.e., the cathode electrode and/or shield portions) was grounded (i.e., coupled to ground node 1853). A control system 1860 can be provided to monitor and control the various elements in system 1800. Other components can also be provided, such as resistor 1854 for providing a voltage divider for measuring voltage. The pulse duration preferably is short enough to prevent the occurrence of a transition from streamer to arc. Those skilled in the art will readily see that a variety of circuits may be used and pulses having different characteristics may readily be achieved.

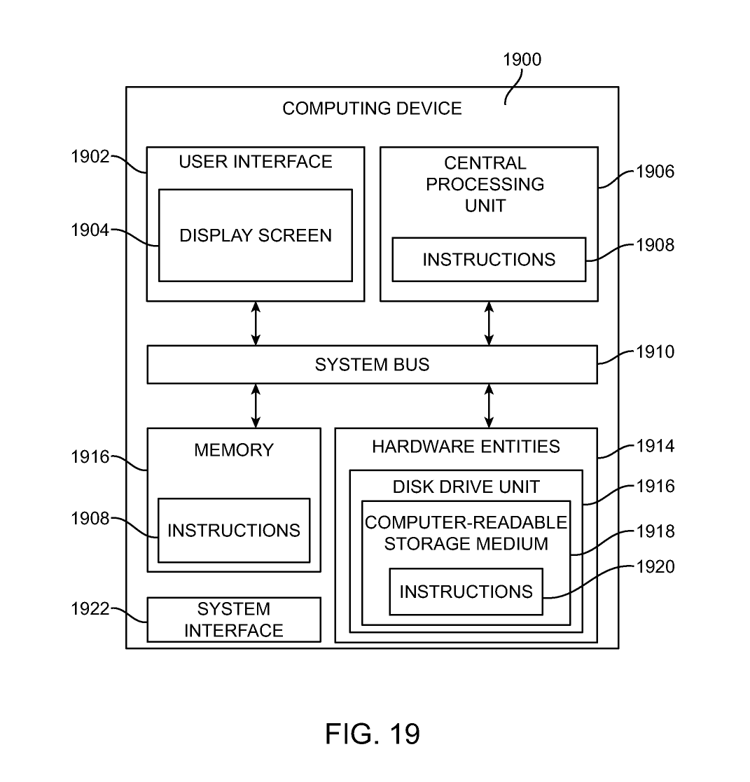

Referring now to FIG. 19, there is provided a detailed block diagram of a computing device 1900 which can be implemented as control system 1860. Although various components are shown in FIG. 19, the computing device 1900 may include more or less components than those shown in FIG. 19. However, the components shown are sufficient to disclose an illustrative embodiment of the invention. The hardware architecture of FIG. 19 represents only one embodiment of a representative computing device for controlling a jointed mechanical device.

As shown in FIG. 19, computing device 1900 includes a system interface 1922, a Central Processing Unit (CPU) 1906, a system bus 1910, a memory 1916 connected to and accessible by other portions of computing device 1900 through system bus 1910, and hardware entities 1914 connected to system bus 1910. At least some of the hardware entities 1914 perform actions involving access to and use of memory 1916, which may be any type of volatile or non-volatile memory devices. Such memory can include, for example, magnetic, optical, or semiconductor based memory devices. However the various embodiments of the invention are not limited in this regard.

In some embodiments, computing system can include a user interface 1902. User interface 1902 can be an internal or external component of computing device 1900. User interface 1902 can include input devices, output devices, and software routines configured to allow a user to interact with and control software applications installed on the computing device 1900. Such input and output devices include, but are not limited to, a display screen 1904, a speaker (not shown), a keypad (not shown), a directional pad (not shown), a directional knob (not shown), and a microphone (not shown). As such, user interface 1902 can facilitate a user-software interaction for launching software development applications and other types of applications installed on the computing device 1900.

System interface 1922 allows the computing device 1900 to communicate directly or indirectly with the other devices, such as an external user interface or other computing devices. Additionally, computing device can include hardware entities 1914, such as microprocessors, application specific integrated circuits (ASICs), and other hardware. As shown in FIG. 19, the hardware entities 1914 can also include a removable memory unit 1916 comprising a computer-readable storage medium 1918 on which is stored one or more sets of instructions 1920 (e.g., software code) configured to implement one or more of the methodologies, procedures, or functions described herein. The instructions 1920 can also reside, completely or at least partially, within the memory 1916 and/or within the CPU 1906 during execution thereof by the computing device 1900. The memory 1916 and the CPU 1906 also can constitute machine-readable media.

While the computer-readable storage medium 1918 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to solid-state memories (such as a memory card or other package that houses one or more read-only (non-volatile) memories, random access memories, or other re-writable (volatile) memories), magneto-optical or optical medium (such as a disk or tape). Accordingly, the disclosure is considered to include any one or more of a computer-readable storage medium or a distribution medium, as listed herein and to include recognized equivalents and successor media, in which the software implementations herein are stored.

System interface 1922 can include a network interface unit configured to facilitate communications over a communications network with one or more external devices. Accordingly, a network interface unit can be provided for use with various communication protocols including the IP protocol. Network interface unit can include, but is not limited to, a transceiver, a transceiving device, and a network interface card (NIC).

As noted above, those skilled in the art will recognize that such a plasma reactor may not only be used with conventional gas treatment, but also for decontamination, odor control, etc. While the description above refers to particular embodiments of the invention, it will be understood that many modifications may be made without departing from the spirit thereof. The accompanying claims are intended to cover such modifications as would fall within the true scope and spirit of the invention.

Applicants presented certain theoretical aspects above that are believed to be accurate that appear to explain observations made regarding embodiments of the invention. However, embodiments of the invention may be practiced without the theoretical aspects presented. Moreover, the theoretical aspects are presented with the understanding that Applicants do not seek to be bound by the theory presented.

While various embodiments of the invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. For example, any configurations described herein with respect to specific dimensions and other characteristics are provided for illustrative purposes only and any other combination of dimensions and characteristics can be used in the various embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A system for the treatment of a gas, comprising:
a gas inlet for receiving the gas prior to treatment;
a plurality of dielectric sections defining two or more discharge chambers coupled to the gas inlet;
first and second electrodes disposed in each of the discharge chambers;
electrically conductive shield portions positioned between adjacent ones of the discharge chambers;
a gas outlet coupled to the discharge chambers; and
a circuit in communication with the shield portions and the first and the second electrodes in the discharge chambers,
wherein the circuit is configured for creating a pulsed electric field between the first and second electrodes and for applying a reference voltage to the shield portions, and
wherein the plurality of dielectric sections and the first and second electrodes are arranged so that a greater portion of overall energy density of a corona discharge within the discharge chambers is due to the surface-streamers.

2. The system of claim 1, wherein the adjacent ones of the discharge members are separated by one of the plurality of dielectric sections, and wherein the shield portions are embedded in the one of the plurality of dielectric sections.

3. The system of claim 1, wherein the adjacent ones of the discharge members are separated by two of the plurality of dielectric sections, and wherein the shield portions are located between the two of the plurality of dielectric sections.

4. The system of claim 1, wherein the shield portions are electrically coupled to the second electrodes.

5. The system of claim 1, wherein the shield portions comprise at least one of an electrically conductive sheet and an electrically conductive mesh.

6. The system of claim 1, wherein the first electrode is a wire.

7. The system of claim 1, wherein the second electrode comprises one of an electrically conductive sheet and an electrically conductive mesh.

8. The system of claim 1, wherein the first and the second electrodes are in a wire-to-plate or wire-to-wire relationship.

9. The system of claim 1, wherein at least a portion of the discharge chambers are coupled in series with respect to the gas inlet and the gas outlet.

10. The system of claim 1, wherein at least a portion of the discharge chambers are coupled in parallel with respect to the gas inlet and the gas outlet.

11. A system for the treatment of a gas, comprising:
a gas inlet for receiving the gas prior to treatment;
a plurality of dielectric sections defining two or more discharge chambers coupled to the gas inlet;
one or more sets of first and second electrodes disposed in each of the discharge chambers;
a gas outlet coupled to the discharge chambers; and
a circuit in communication with the sets of first and the second electrodes in the discharge chambers,
wherein the circuit is configured for creating a pulsed electric field for each of the sets of the first and second electrodes,
wherein the plurality of dielectric sections and the sets of first and second electrodes are arranged so that a greater portion of overall energy density of a corona discharge within the discharge chambers is due to the surface-streamers, and
wherein the sets of first and second electrodes associated with adjacent ones of the discharge chambers are positioned in a staggered arrangement such that the pulsed electric field in a first of the adjacent ones of the discharge chambers does not substantially interacting with the pulsed electric field in a second of the adjacent ones of discharge chambers.

12. The system of claim 11, wherein the first electrode is a wire.

13. The system of claim 11, wherein the first and the second electrodes in each of the sets are in a substantially coaxial relationship.

14. The system of claim 11, wherein at least a portion of the discharge chambers are coupled in series with respect to the gas inlet and the gas outlet.

15. The system of claim 11, wherein at least a portion of the discharge chambers are coupled in parallel with respect to the gas inlet and the gas outlet.

16. A method for the treatment of a gas, the method comprising:
providing two or more discharge chambers defined by a plurality of dielectric sections, each of the discharge chambers comprising one or more sets first and second electrodes for producing electric fields in the discharge chambers, the plurality of dielectric sections and the sets of first and second electrodes arranged to define a volume in each of the discharge chambers that inhibits the formation of volume-streamers, and the discharge chambers being configured to prevent pulsed electric fields generated in adjacent ones of the discharge chambers from substantially interacting;
directing the gas into the discharge chambers; and
treating the gas using a corona discharge in the discharge chambers produced by a pulsed electric field generated by each of the sets of the first and second electrodes in the discharge chambers.

17. The method of claim 16, wherein the step of providing further comprises inserting electrically conductive shield portions between the adjacent ones of the discharge chambers, and wherein the step of treating further comprises applying a reference voltage to the shield portions.

18. The method of claim 16, wherein the step of providing further comprises electrically coupling the shield portions to the second electrodes.

19. The method of claim 16, wherein the step of providing further comprises positioning the sets of first and second electrodes in the adjacent ones of the discharge chambers in a staggered arrangement.

20. A system for the treatment of a gas, comprising:
a gas inlet for receiving the gas prior to treatment;
a plurality of dielectric sections defining two or more adjacent discharge chambers coupled to the gas inlet;
first and second electrodes disposed in each of the discharge chambers;
a gas outlet coupled to the discharge chambers; and
a circuit in communication with the first and the second electrodes in the discharge chambers,
wherein the circuit is configured for creating a pulsed electric field between the first and second electrodes, wherein the plurality of dielectric sections and the first and second electrodes are arranged so that a greater portion of overall energy density from a corona discharge within the discharge chambers is due to the surface-streamers, and wherein the first and second electrodes in a first of the discharge chambers and the first and second electrodes in a second of the discharge chambers adjacent to the first of the discharge chambers are positioned in a staggered arrangement.

21. A system for the treatment of a gas, comprising:
a gas inlet for receiving the gas prior to treatment;
a plurality of dielectric sections defining two or more adjacent discharge chambers coupled to the gas inlet;
first and second electrodes disposed in each of the discharge chambers;
a gas outlet coupled to the discharge chambers; and
a circuit in communication with the first and the second electrodes in the discharge chambers,
wherein the circuit is configured for creating a pulsed electric field between the first and second electrodes, wherein the plurality of dielectric sections and the first and second electrodes are arranged so that a greater portion of overall energy density from a corona discharge within the discharge chambers is due to the surface-streamers, wherein the first electrode in a first of the discharge chambers and the second electrode in a second of the discharge chambers adjacent to the first of the discharge chambers are co-located, and wherein the second electrode in the first of the discharge chambers and the first electrode in the second of the discharge chambers adjacent to the first of the discharge chambers are co-located.
